(19) United States
(12) Patent Application Publication
(10) Pub. No.: US 2026/0211583 A1
(43) Pub. Date: Jul. 23, 2026

(54) ELECTRONIC SYSTEM AND OPERATION METHOD THEREOF, COMPUTATIONAL STORAGE SYSTEM AND HOST

(71) Applicant: YANGTZE MEMORY TECHNOLOGIES CO., LTD., Wuhan (CN)

(72) Inventor: Tianyi WANG, Wuhan (CN)

(21) Appl. No.: 19/412,599

(22) Filed: Dec. 8, 2025

(30) Foreign Application Priority Data
Jan. 23, 2025 (CN) 2025101093213

(51) Int. Cl. G06F 3/06

(52) U.S. Cl. CPC G06F 3/0659; G06F 3/0604; G06F 3/0679

(57) ABSTRACT

An electronic system comprises a host and a computational storage system coupled to the host, the computational storage system comprising a controller. The host is configured to send a first command. The controller is configured to receive the first command; and acquire information related to time required for executing each program by the computational storage system in response to the first command. The host is configured to perform task allocation related to program execution according to the information related to the time required for executing each program by the computational storage system.

### CROSS-REFERENCE TO RELATED APPLICATIONS

The present disclosure claims priority to Chinese Patent Application No. 2025101093213, which was filed January 23, 2025, and is hereby incorporated herein by reference in its entirety.

### FIELD OF TECHNOLOGY

The present disclosure relates to, but is not limited to, an electronic system and an operation method thereof, a computational storage system and a host.

### BACKGROUND

Semiconductor memories may be roughly divided into two types, depending on whether they retain stored data when powered down. These two types of semiconductor memories are: a volatile memory and a non-volatile memory, where the volatile memory loses stored data when powered down, and the non-volatile memory retains stored data when powered down.

### SUMMARY

According to a first aspect of the implementations of the present disclosure, it provides an electronic system including a host and a computational storage system coupled to the host. The computational storage system includes a controller. The host is configured to: send a first command. The controller is configured to: receive the first command; acquire information related to time required for executing each program by the computational storage system in response to the first command. The host is configured to: perform task allocation related to program execution according to the information related to the time required for executing each program by the computational storage system.

In some implementations, the information related to the time required for executing each program by the computational storage system includes time required for processing a unit data volume when the computational storage system executes each program.

In some implementations, the host is configured to: determine a program that needs to be executed within a preset time period according to the information related to the time required for executing each program by the computational storage system.

In some implementations, the host is configured to: send a second command. The controller is configured to: receive the second command; acquire whether the computational storage system supports querying the information related to the time required for executing each program by the computational storage system in response to the second command. The host is configured to: send the first command based on the computational storage system supports querying the information related to the time required for executing each program by the computational storage system.

In some implementations, the controller is configured to: calculate the information related to the time required for executing each program by the computational storage system according to a type of each program and a hardware configuration of the computational storage system.

In some implementations, the computational storage system further includes a first storage area, and the first storage area is coupled to the controller; the controller is configured to: store the calculated information related to the time required for executing each program by the computational storage system into the first storage area; and acquire, from the first storage area, the information related to the time required for executing each program by the computational storage system in response to the first command.

In some implementations, a first table is stored in the first storage area, and information describing each program is recorded in the first table. The controller is configured to: record the information related to the time required for executing each program by the computational storage system in the first table.

In some implementations, the first command includes a command to get program list log page.

In some implementations, a second table is stored in the first storage area, and information describing a compute namespace is recorded in the second table. The controller is configured to: record, in the second table, whether the computational storage system supports querying the information related to the time required for executing each program by the computational storage system.

In some implementations, the second command includes an identify command.

In some implementations, the computational storage system includes a computing processing component configured to execute a program and a second storage area coupled to the controller. The controller is configured to: receive a third command; and configure a corresponding storage area in the second storage area for data during the computing processing component executing the program, in response to the third command.

In some implementations, the computational storage system further includes a third storage area coupled to the controller. The controller is configured to: write input data during program execution stored in the third storage area into the second storage area; and write output data during program execution stored in the second storage area into the third storage area.

In some implementations, the computational storage system further includes a non-volatile memory namespace, a compute namespace, and a sub-system local memory namespace. The compute namespace comprises the computing processing component, the sub-system local memory namespace comprises the second storage area, and the non-volatile memory namespace comprises the third storage area.

According to a second aspect of the implementations of the present disclosure, it provides a computational storage system, where the computational storage system includes a controller and a first storage area coupled to the controller, the controller being configured to: receive a first command; acquire, from the first storage area, information related to time required for executing each program by the computational storage system in response to the first command; and send the information related to the time required for executing each program by the computational storage system to a host coupled to the computational storage system,.

In some implementations, the information related to the time required for executing each program by the computational storage system comprises time required for processing a unit data volume when the computational storage system executes each program.

In some implementations, the controller is configured to: receive a second command; acquire whether the computational storage system supports querying the information related to the time required for executing each program by the computational storage system in response to the second command; and receive the first command based on computational storage system supports querying the information related to the time required for executing each program by the computational storage system.

In some implementations, the controller is configured to: calculate the information related to the time required for executing each program by the computational storage system according to a type of each program and a hardware configuration of the computational storage system.

In some implementations, the controller is configured to: store the calculated information related to the time required for executing each program by the computational storage system into the first storage area.

According to a third aspect of the implementations of the present disclosure, it provides a host configured to: send a first command to a computational storage system coupled to the host; acquire, from the computational storage system, information related to time required for executing each program by the computational storage system; and perform task allocation related to program execution according to the information related to the time required for executing each program by the computational storage system.

According to a fourth aspect of the implementations of the present disclosure, it provides an operation method of an electronic system, comprising: sending, by a host, a first command; receiving, by a controller, the first command; acquiring, by the controller, information related to time required for executing each program by the computational storage system in response to the first command; and performing, by the host, task allocation related to program execution according to the information related to the time required for executing each program by the computational storage system.

In some implementations, the information related to the time required for executing each program by the computational storage system comprises time required for processing a unit data volume when the computational storage system executes each program.

In some implementations, the performing, by the host, the task allocation related to program execution according to the information related to the time required for executing each program by the computational storage system includes: determining, by the host, a program that needs to be executed within a preset time period according to the information related to the time required for executing each program by the computational storage system.

In some implementations, the operation method further comprises: sending, by the host, a second command; receiving, by the controller, the second command; acquiring, by the controller, whether the computational storage system supports querying the information related to the time required for executing each program by the computational storage system in response to the second command; and sending, by the host, the first command based on the computational storage system supports querying the information related to the time required for executing each program by the computational storage system.

In some implementations, the operation method further comprises: calculating, by the controller, the information related to the time required for executing each program by the computational storage system according to a type of each program and a hardware configuration of the computational storage system.

In some implementations, the computational storage system further comprises a first storage area, the first storage area being coupled to the controller. The operation method further comprises: storing the calculated information related to the time required for executing each program by the computational storage system into the first storage area. The acquiring, by the controller, the information related to the time required for executing each program by the computational storage system in response to the first command comprises: acquiring, by the controller, the information related to the time required for executing each program by the computational storage system from the first storage area in response to the first command.

In some implementations, a first table is stored in the first storage area, and information describing each program is recorded in the first table. The operation method further comprises: recording, by the controller, the information related to the time required for executing each program by the computational storage system in the first table.

In some implementations, the first command comprises a command to get program list log page.

In some implementations, a second table is stored in the first storage area, and information describing a compute namespace is recorded in the second table. The operation method further comprises: recording, by the controller, whether the computational storage system supports querying the information related to the time required for executing each program by the computational storage system in the second table.

In some implementations, the second command includes an identify command.

In implementations of the present disclosure, a host sends a first command, and after receiving the first command, a controller acquires information related to time required for executing each program by a computational storage system in response to the first command, and the host may perform task allocation related to program execution according to the information related to the time required for executing each program by the computational storage system. According to the implementations of the present disclosure, the host is allowed to know the information related to the time required for executing each program by the computational storage system, so that the host can coordinate computing tasks according to the information, perform better evaluation on performance, better coordinate computing resources, and efficiently allocate and schedule programs.

### BRIEF DESCRIPTION OF THE DRAWINGS

FIG. 1 is a first schematic structural diagram of an electronic system according to an implementation of the present disclosure;

FIG. 2 is a first schematic structural diagram of a computational storage system according to an implementation of the present disclosure;

FIG. 3 is a schematic diagram of an example of loading programs in an electronic system according to an implementation of the present disclosure;

FIG. 4 is a schematic diagram of an example of program execution in an electronic system according to an implementation of the present disclosure;

FIG. 5 is a schematic diagram of a memory range and a memory range set according to an implementation of the present disclosure;

FIG. 6 is a second schematic structural diagram of an electronic system according to an implementation of the present disclosure;

FIG. 7 is a third schematic structural diagram of an electronic system according to an implementation of the present disclosure;

FIG. 8 is a fourth schematic structural diagram of an electronic system according to an implementation of the present disclosure;

FIG. 9 is a fifth schematic structural diagram of an electronic system according to an implementation of the present disclosure;

FIG. 10 is a schematic diagram of an operation flow of an electronic system according to an implementation of the present disclosure;

FIG. 11 is a sixth schematic structural diagram of an electronic system according to an implementation of the present disclosure;

FIG. 12 is a second schematic structural diagram of a computational storage system according to an implementation of the present disclosure;

FIG. 13 is a schematic flowchart of an operation method of an electronic system according to an implementation of the present disclosure.

### DETAILED DESCRIPTION

Embodiments of the present disclosure will be described in more detail below with reference to the figures. While implementations of the present disclosure are shown in the figures, it should be understood that the disclosure may be implemented in various forms and should not be limited by the specific implementations set forth herein. Rather, these implementations are provided to enable a more thorough understanding of the present disclosure and to fully convey the scope of the disclosure to those skilled in the art.

In the following description, numerous specific details are given in order to provide a more thorough understanding of the present disclosure. It will be apparent to those skilled in the art, however, that the present disclosure may be practiced without one or more of these details. In other examples, to avoid confusion with the present disclosure, some technical features known in the art are not described; for example, not all features of the actual implementations are described herein, and well-known functions and structures are not described in detail.

In the figures, like reference numerals refer to like elements throughout.

It should be understood that spatial relation terms such as “under”, “underneath”, “nether”, “below”, “over”, “above”, etc., may be used herein for ease of description to describe relationship between one element or feature and other elements or features shown in the figures. It should be appreciated that, in addition to orientations shown in the figures, the spatial relation term is intended to further includes different orientations of devices in use and operation. For example, if the devices in the figures are flipped, then described as “underneath” or “below” or “under” other elements will be oriented to be “on” other elements or features. Thus, the example terms “underneath” and “under” may include both orientations of up and down. The devices may be additionally oriented (rotated by 90 degrees or other orientations) and the spatial description term used herein is interpreted accordingly.

The term used herein is for the purpose of describing particular implementations only and is not intended as a limitation of the present disclosure. As used herein, the singular forms “a,” “an,” and “the” are intended to include plural forms as well, unless the context clearly shows alternative ways. It should also be understood that the terms “composition” and/or “comprising”, when used in this specification, determine the presence of stated features, integers, steps, operations, elements, and/or components, but do not preclude the presence or addition of one or more other features, integers, steps, operations, elements, components, and/or groups. As used herein, the term “and/or” includes any and all combinations of related listed items.

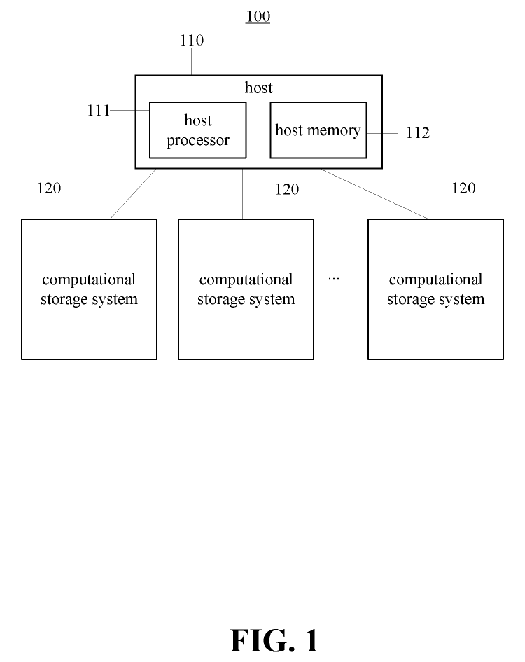

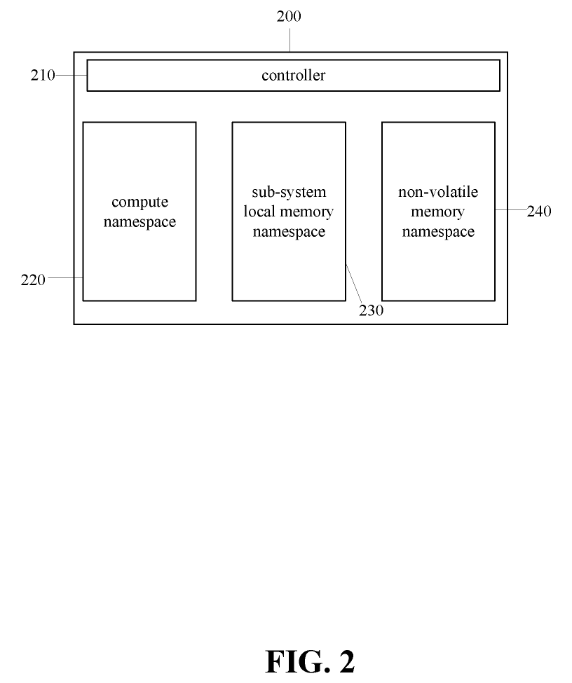

FIG. 1 is a schematic structural diagram of an electronic system according to an implementation of the present disclosure. FIG. 2 is a schematic structural diagram of a computational storage system according to an implementation of the present disclosure.

Referring to FIG. 1, an electronic system 100 may include a host 110 and at least one computational storage system 120. The host 110 may include a host processor 111 and a host memory 112. The host processor 111 may control the overall operation of the host 110. The host processor 111 may be implemented as at least one of various processing units (including, for example, a central processing unit (CPU), an application processor (AP), a graphics processing unit (GPU), a neural processor unit (NPU), a field programmable gate array (FPGA), and/or a microprocessor). In some implementations, the host processor 111 may be implemented as a System on Chip (SoC). The host memory 112 may store data, instructions, and programs needed for the operation of the host processor 111. The host memory 112 may be a volatile memory. The volatile memory includes, but is not limited to, random access memory (RAM), dynamic random access memory (DRAM), static random access memory (SRAM), synchronous dynamic random access memory (SDRAM), double data rate synchronous dynamic random access memory (DDR).

The computational storage system 120 may be a semiconductor device that provides computing services and data storage services. The computational storage system 120 may be used as both a data storage device in the electronic system 100 and a computing device for executing programs. In some implementations, for example, the computational storage system 120 may be implemented as part of a data center or an artificial intelligence training data device.

In some implementations, the host 110 and the computational storage system 120 may be physically connected through an interface and comply with corresponding PCIe/NVMe protocol communications. For example, the host 110 and the computational storage system 120 may be connected through a network link, for example, based on an NVMe-OF protocol connection. For example, the host 110 and the computational storage system 120 may also be connected through a Compute Express Link (CXL) interface, and the host 110 may control operations of the computational storage system 120 via a Compute Express Link (CXL) interface. The computational storage system 120 is configured to follow compute storage protocols of NVMe. The CXL interface may include CXL.io, CXL.cache, and CXL.mem as sub-protocols. The host 110 may load predetermined programs to the computational storage system 120 for processing. The host 110 may load various types of programs, such as applications, kernels, and/or computations, to the computational storage system 120. The programs may include, for example, encryption programs, compression programs, image recognition programs, filtering programs, and/or artificial intelligence programs.

Referring to FIG. 2, in some implementations, the computational storage system 200 may include a controller 210, one or more sub-system local memory namespaces 230, one or more non-volatile memory Namespaces 240, and one or more compute namespaces 220. The computational storage system 200 may correspond to one of a plurality of computational storage systems 120 shown in FIG. 1. The sub-system local memory namespace 230 may be a namespace implemented by a volatile memory that is closer to computing processing components of the compute namespace 220 relative to a namespace implemented by a non-volatile storage. The non-volatile memory namespace 240 may be a namespace implemented by a non-volatile memory.

In some implementations, the computational storage system 200 may use non-volatile memory express protocols as storage protocols, and the controller 210 may be an NVMe controller. The controller 210 may store input data/output data during program execution in the sub-system local memory namespace 230 and/or read input data/output data stored in the sub-system local memory namespace 230, in response to an input/output (I/O) request from the host.

In some implementations, the controller 210 may execute various operations for controlling the non-volatile memory namespace 240 or other non-volatile storage device. For example, the various operations may include an address mapping operations, a wear leveling operation, and/or a garbage collection operation. The address mapping operation may be a translation operation between a logical address managed by the host or the controller and a physical address of the non-volatile memory namespace 240. The wear leveling may be an operation that equalizes the usage frequency or number of multiple storage blocks included in the non-volatile memory namespace 240. The garbage collection operation may be an operation of copying valid data from a source block of the non-volatile memory namespace 240 to a target block and then erasing the source block to enable available blocks or free blocks in the non-volatile memory namespace 240.

In some implementations, the compute namespace 220 may be used as an abstraction that represents one or more computing engines for executing programs. The computing engine resources may be composed of one or more of a CPU, a FPGA, a GPU, an ASIC, or the like. For example, the compute namespace may include a CPU core and a FPGA. The computing engine resources may be a part of the controller 210, or may be a part other than the controller 210. A computing engine may execute a program pre-loaded from the host. In some implementations, the program may be stored in a program slot. The program slot may be formed in the computing engine, or may be allocated in separate memories. In some implementations, a program slot in which a program is stored may be within the compute namespace 220, or may form the compute namespace 220, which is an entity capable of executing programs. The compute namespace 220 may be, for example, an entity in an NVMe sub-system. The compute namespace 220 can access the sub-system local memory namespace 230. In some implementations, the computational storage system 200 may include one or more compute namespaces 220. If the computational storage system 200 includes multiple compute namespaces 220, the host may load multiple programs to multiple compute namespaces 220, respectively (e.g., in a one-to-one relationship). Thus, each loaded program may be managed in the respective compute namespace 220, and the present disclosure is not limited thereto.

In some implementations, the controller 210 may copy data stored in the non-volatile memory namespace 240 to the sub-system local memory namespace 230, and/or may copy data stored in the sub-system local memory namespace 230 to the non-volatile memory namespace 240, for example, the controller 210 may control data migration of the non-volatile memory namespace 240 and the local memory namespace 230 according to the need for program processing of the compute namespace 220.

The sub-system local memory namespace 230 may store input data to be used by programs to be executed, or may store results obtained from executing programs (output data). In some implementations, the sub-system local memory namespace 230 may also be accessed by the controller 210. The sub-system local memory namespace 230 may be implemented, for example, as a DRAM.

In some implementations, the controller 210 may also include a first control part (not shown) that controlling the sub-system local memory namespace 230, such as a cache controller. In some implementations, the first control portion may be provided as a chip separate from the controller 210. In some other implementations, the first control portion may be provided as an internal component of the controller 210.

The non-volatile memory namespace 240 may store input/output data during program execution. The non-volatile memory namespace 240 may include, for example, a flash memory such as a NAND flash memory. In another implementation, the non-volatile memory namespace 240 may include, for example, a phase change memory, a resistive memory, a magneto resistive memory, a ferroelectric memory, or a polymer memory. In some implementations, the computational storage system 200 may also include a second control part that controls or is configured to control the non-volatile memory namespace 240, such as a flash controller, where the second control part may be included in the controller 210.

In implementations of the present disclosure, computing processing components in the computational storage system includes computing engine resources that are abstracted into one or more compute namespaces for use by a user. The RAM in the computing processing components in the computational storage system, and the RAM public in the computational storage system, and the RAM in the controller may be abstracted into sub-system local namespaces for use by a user. For a user, these compute namespaces and the sub-system local memory namespaces are in a parallel relationship, and in some implementations, the user may be informed that a certain sub-system local memory namespace is used by a certain compute namespace (because of a physical dependency), according to an internal specific physical implementation.

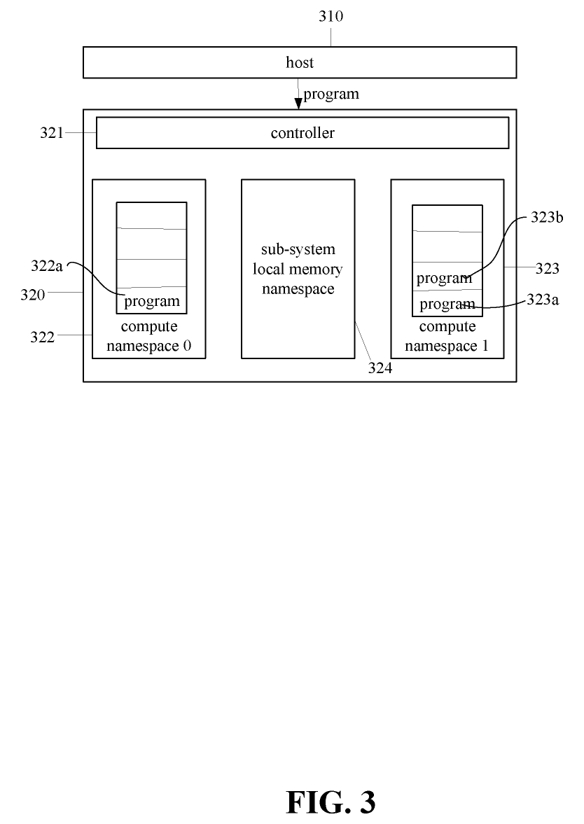

FIG. 3 is a schematic diagram of an example of loading programs in an electronic system according to an implementation of the present disclosure.

Referring to FIG. 3, a host 310 may load programs to a computational storage system 320. In FIG. 3, the computational storage system 320 is shown to include a compute namespace 322 and a compute namespace 323 (e.g., compute namespaces 0 and 1), but the number of compute namespaces is not limited thereto.

In some implementations, the compute namespace 322 and the compute namespace 323 may support device-defined programs and/or downloadable programs. The device-defined programs may be, for example, fixed programs provided by a manufacturer, and the downloadable programs may be programs loaded into the compute namespace 322 and the compute namespace 323 by the host 310. For example, a device-defined program 323a may be disposed in the compute namespace 323.

In some implementations, a controller 321 of the computational storage system 320 may receive programs 322a and 323b transmitted from the host 310 and store them in the computational storage system 320. The computing engines of the compute namespace may execute programs 322a, 323a, and/or 323b in the compute namespace 322 and the compute namespace 323 using input data stored in the sub-system local memory namespace 324, in response to a program execution command from the host 310, where the input data may be respective input parameters required for program execution, and/or the like.

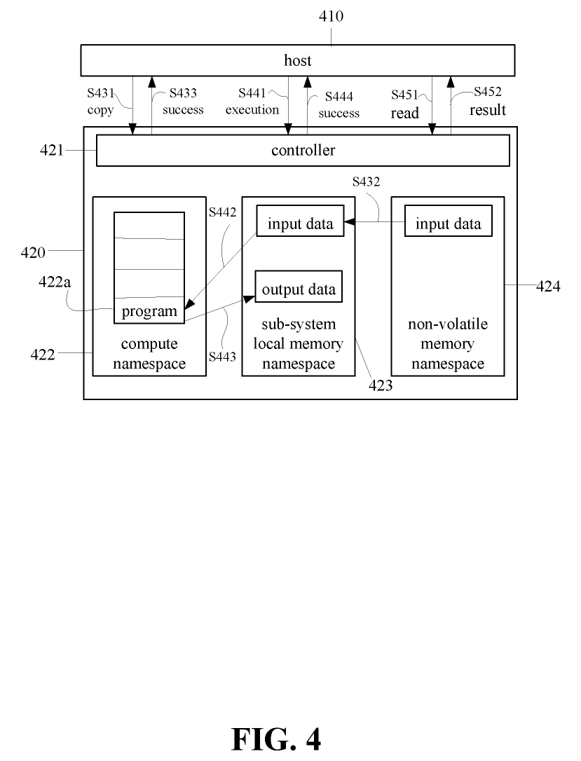

FIG. 4 is a schematic diagram of an example of program execution in an electronic system according to an implementation of the present disclosure. In FIG. 4, it is assumed that a program 422a is loaded into a compute namespace 422 of a computational storage system 420.

Referring to FIG. 4, in operation S431, a host 410 may send a data copy command to a controller 421 of the computational storage system 420. In operation S432, in response to a data copy command, input data stored in a non-volatile memory namespace 424 (e.g., a non-volatile memory device) may be copied to a sub-system local memory namespace 423. In some implementations, the controller 421 may, in response to a data copy command, control the non-volatile memory namespace 424 and the sub-system local memory namespace 423 to transfer input data from the non-volatile memory namespace 424 to the sub-system local memory namespace 423.

It should be noted that, FIG. 4 is only an example, and is not intended to limit transmission paths of the input data and output data in the implementations of the present disclosure. In some implementations, the host 410 may directly write the input data into the sub-system local memory namespace 423, and store the output data obtained after the program processes the output data in the sub-system local memory namespace 423, and the host 410 may directly obtain the output data from the sub-system local memory namespace 423. For example, the non-volatile memory namespace 424 may not participate in storage of the input data and storage of the output data. In some other implementations, the non-volatile memory namespace 424 may also participate in the storage of the input data and the storage of the output data. The host 410 may write the input data into the non-volatile memory namespace 424, the non-volatile memory namespace 424 copies the input data to the sub-system local memory namespace 423, the output data obtained after the program processes the input data is stored in the sub-system local memory namespace 423, the output data in the sub-system local memory namespace 423 is copied into the non-volatile memory namespace 424, and the host may obtain the output data from the non-volatile memory namespace 424. In still other implementations, the non-volatile memory namespace 424 may only participate in one of the storage of the input data and the storage of the output data. For example, the host 410 may directly write the input data into the sub-system local memory namespace 423, the output data obtained after the program processes the input data is stored in the sub-system local memory namespace 423, the output data in the sub-system local memory namespace 423 is copied into the non-volatile memory namespace 424, and the host 410 may obtain the output data from the non-volatile memory namespace 424. Or the host 410 may write the input data into the non-volatile memory namespace 424, the input data in the non-volatile memory namespace 424 is copied to the sub-system local memory namespace 423, the output data obtained after the program processes the input data is stored in the sub-system local memory namespace 423, and the host 410 may directly obtain the output data from the sub-system local memory namespace 423.

After copying data from the NVM namespace 424 to the sub-system local memory namespace 423, the controller 421 may send a read success message to the host 410 in operation S433.

To execute the program, in operation S441, the host 410 may send a program execution command to the computational storage system 420 to execute the program 422a in the compute namespace 422. In some implementations, the controller 421 may receive a program execution command from the host 410. In operation S442, in response to the program execution command, a computing engine in the compute namespace 422 may execute the program 422a in the compute namespace 422 using the input data stored in the sub-system local memory namespace 423. In operation S443, the compute namespace may store execution results of the program 422a (output data) in the sub-system local memory namespace 423. After the execution of the program 422a in the compute namespace 422 is completed, in operation S444, the controller 421 may send a message indicating successful execution of the program to the host 410.

In some implementations, in operation S451, the host 410 may send a read command indicating to read the output data from the sub-system local memory namespace 423, to the computational storage system 420. In operation S452, the controller 421 may read the output data (e.g., the execution results of the program 422a) from the sub-system local memory namespace 423 and transmit the data to the host 410.

In some implementations, after execution of the program 422a is completed, the output data may be brushed from the sub-system local memory namespace 423 to the non-volatile memory namespace 424.

The electronic system may execute programs on the computational storage system 420 by performing the operations described above. Further, if requested by the host 410, the electronic system may provide the execution results of the program from the computational storage system 420 to the host 410.

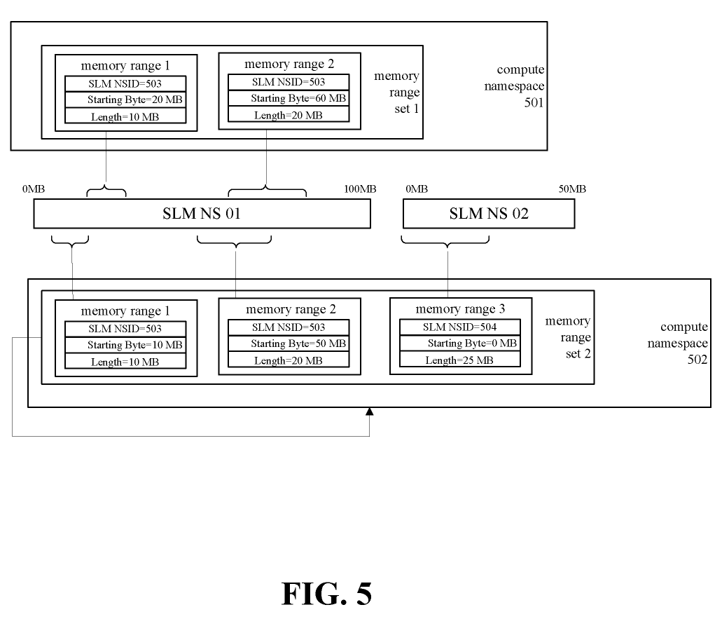

In some implementations, the controller 421 configures a corresponding storage area in the memory device of the sub-system local memory namespace 423, in response to a command of the host, for storing the input data/output data during program execution. In some implementations, the controller may configure a corresponding storage area by creating a memory range, where a memory range (MR) may define a corresponding storage area, where the memory range may be represented by an sub-system local memory namespaces identity (SLM NS ID), a starting address of the storage area in the local memory namespace (Starting Byte), and a data length (Length), and each memory range may specify a range in which the sub-system local memory namespace can be accessed. The collection of memory ranges constitutes a memory range set (MRS). The memory range set may be stored in a compute namespace, where each execution of a program being limited to access a range other than the range specified by the memory range set in the program name. As shown in FIG. 5, a memory range 1 and a memory range 2 in a compute namespace 501 constitute a memory range set 1, where a memory range 1, a memory range 2, and a memory range 3 in a compute namespace 502 constitute a memory range set 2, each memory range including an sub-system local memory namespace identity (SLM NS ID), a starting address of the storage area in the local memory namespace (Starting Byte), and information related to a data length (Length), where an area in the sub-system local memory namespace corresponding to the memory range can be obtained through information included in the memory range. It should be noted that, an example in which the memory range set is stored in the compute namespace is used as an example for description in FIG. 5, but implementations of the present disclosure are not limited thereto, and the memory range set may also be stored in another memory device having a storage function of the computational storage system.

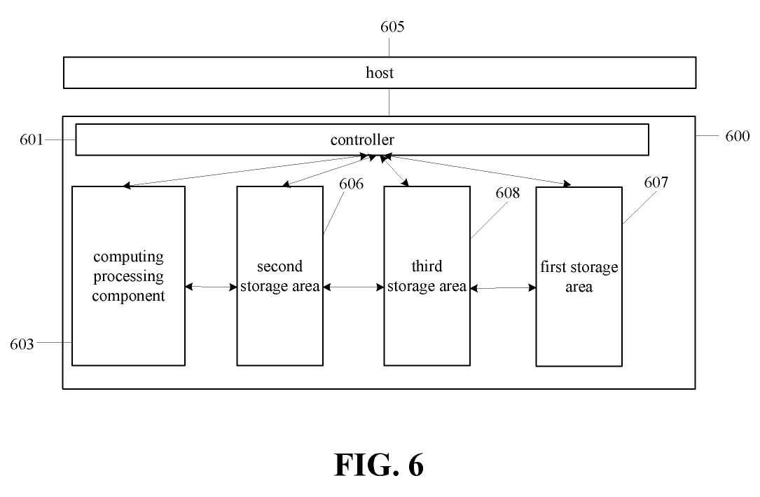

The present disclosure provides an electronic system, as shown in FIG. 6, the electronic system includes a host 605 and a computational storage system 600 coupled to the host 605; the computational storage system 600 includes a controller 601; the host 605 is configured to: send a first command; the controller 601 is configured to: receive a first command; and acquire information related to time required for executing each program by the computational storage system 600 in response to the first command; and the host 605 is configured to: perform task allocation related to program execution according to the information related to the time required for executing each program by the computational storage system 600.

In implementations of the present disclosure, the host 605 sends a first command, and after receiving the first command, the controller 601 acquires the information related to the time required for executing each program by the computational storage system 600 in response to the first command, and the host 605 may perform task allocation related to program execution according to the information related to the time required for executing each program by the computational storage system 600. In implementations of the present disclosure, the host 605 is allowed to know the information related to the time required for executing each program by the computational storage system 600, so that the host 605 can coordinate computing tasks according to that information, perform better evaluation on performance, better coordinate computing resources, and efficiently allocate and schedule programs.

In implementations of the present disclosure, a host processor of the host sends the first command to the controller of the computational storage system through an interface between the host and the computational storage system.

In some implementations, the information related to the time required for executing each program by the computational storage system 600 includes time required for processing a unit data volume when the computational storage system 600 executes each program.

It can be understood that, the data volume processed by the same program each time may be different, and in the case that the data volume processed by the same program is different, time required for executing the program is also different. Taking the same program processing a data volume of 1G and processing a data volume of 2G as an example, time required for processing the data volume of 1G is less than time required for processing the data volume of 2G, and the larger the data volume of data processed by the same program is, the longer the time required for executing the program is. Therefore, for each program, the speed of program execution may be represented by time required for processing the unit data volume by the program. Taking a unit data volume of 1G as an example, time required for processing the unit data volume when the computational storage system 600 executes each program is time required for processing the data volume of 1G during execution of each program . After obtaining the information related to the time required for executing each program by the computational storage system 600, the host 605 may acquire the time required for executing the program according to the information and the data volume actually required to be processed by the program.

It should be noted that, the unit data volume given above is merely an example, and is not used to limit the unit data volume in the implementations of the present disclosure. Unit data volumes corresponding to different programs may be the same or different.

The program in the implementations of the present disclosure includes a fixed program that comes with the computational storage system 600 provided by the manufacturer and a program downloaded by the user into the computational storage system 600.

In some implementations, the host 605 is configured to: determine a program that needs to be executed within a preset time period according to the information related to the time required for executing each program by the computational storage system 600.

In some examples, the host processor of the host determines the program that needs to be executed within the preset time period according to the information related to the time required for executing each program by the computational storage system 600.

The preset time period herein can be understood as a time period of 1 hour, two hours, or another duration, which is not limited in the present disclosure. In the above implementations, task allocation related to program execution by the host 605 can be understood as determining a program that needs to be executed within a preset time period, and determining a program that needs to be executed within a preset time period can be understood as that the host 605 can determine which programs may be executed within, for example, 1 hours, so that the host 605 has better allocation for execution of a plurality of programs.

In some implementations, the controller 601 is configured to: calculate the information related to the time required for executing each program by the computational storage system 600 according to a type of each program and a hardware configuration of the computational storage system 600.

Regarding types of programs, for example, an encryption program, a compression program, an image recognition program, a filtering program, an artificial intelligence program, or a system program, can be understood as different types of programs, and for different types of programs, time required for execution by the computational storage system 600 is different.

The hardware configuration of the computational storage system 600 herein can reflect the execution capability of the computational storage system 600 itself, and the hardware configuration of the computational storage system 600 includes a configuration of a computing resource, where the computing resource include, but are not limited to, one or more of a CPU, a FPGA, a GPU, an ASIC, and the like. Different computing resources have different capabilities to execute the same program; for the same type of computing resource, computing resources of different materials and computing resources with different cores have different capabilities to execute the same program, for example, the capability of executing a program by a single-core CPU is weaker than the capability of executing the same program by a multi-core CPU. In the case that other configurations are same, for the same program, time required for executing the program by a single-core CPU is longer than time required for executing the program and processing the same data volume by the multi-core CPU. Therefore, configurations such as computing resources, numbers of cores of computing resources and materials of computing resources may affect the capability to execute the same program. For the same program, for the hardware configuration of the computational storage system 600 is constant, time required for processing a unit data volume when the computational storage system 600 executes the program is constant.

In some implementations, as shown in FIG. 6, the computational storage system 600 further includes a first storage area 607, where the first storage area 607 is coupled to the controller 601; the controller 601 is configured to: store the calculated information related to the time required for executing each program by the computational storage system 600 into the first storage area 607; and acquire, from the first storage area 607, the information related to the time required for executing each program by the computational storage system 600 in response to the first command.

In implementations of the present disclosure, the controller 601 can acquire the information related to the time required for executing each program by the computational storage system 600 according to a type of each program and the hardware configuration of the computational storage system 600, and place the information in a field that can be acquired by a user. After calculating the information related to the time required for executing each program by the computational storage system 600, the controller 601 can store the information related to the time required for executing each program by the computational storage system 600 in the first storage area 607, and after the controller 601 receives the first command, the controller 601 acquires the information related to the time required for executing each program by the storage system from the first area, in response to the first command.

In implementations of the present disclosure, the first storage area 607 may be a volatile storage area or a non-volatile storage area.

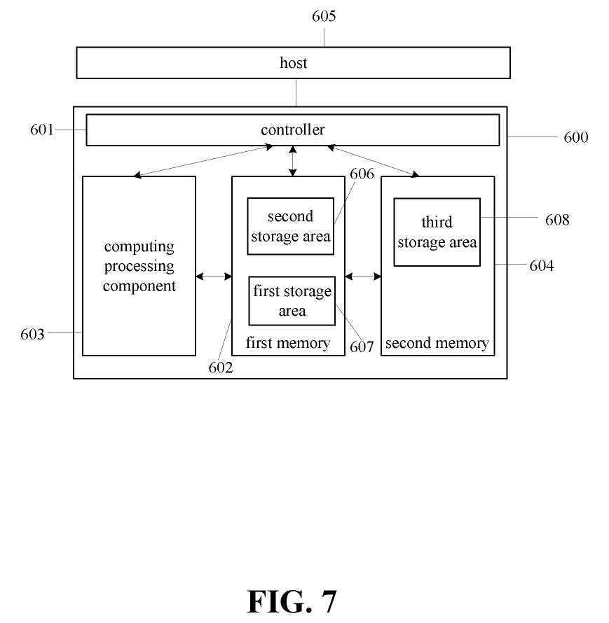

In some implementations, as shown in FIG. 7, the computational storage system 600 includes a first memory 602, where the first memory 602 includes a first storage area 607.

In some implementations, the first memory 602 is a volatile memory, including but not limited to a random access memory (RAM), a dynamic random access memory (DRAM), a static random access memory (SRAM), a synchronous dynamic random access memory (SDRAM), a double data rate synchronous dynamic random access memory (DDR SDRAM).

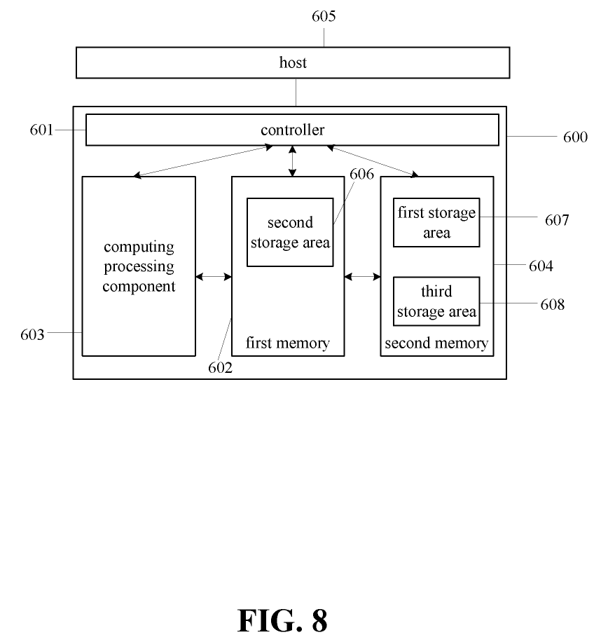

In some implementations, as shown in FIG. 8, the computational storage system 600 further includes a second memory 604 coupled to the controller 601, where the second memory 604 includes a first storage area 607.

In some examples, the second memory 604 is a non-volatile memory, including but not limited to a flash memory such as a NOT AND (NAND) flash memory, a phase change memory, a resistive memory, a magneto resistive memory, a ferroelectric memory, or a polymer memory.

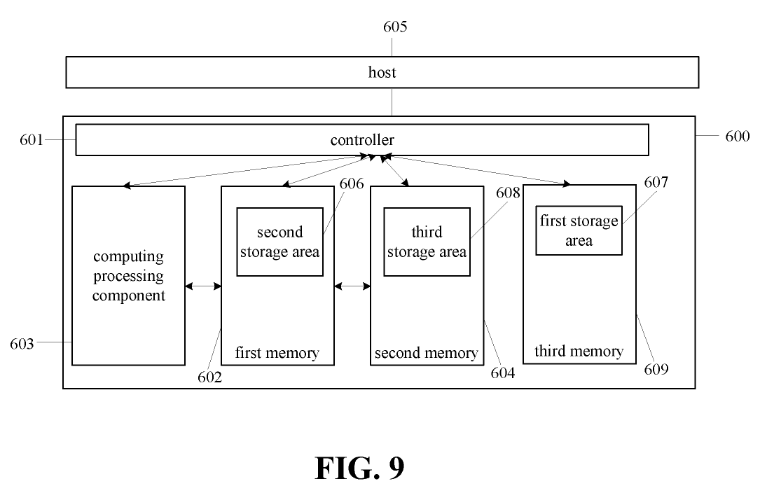

In some implementations, as shown in FIG. 9, the computational storage system 600 further includes a third memory 609 coupled to the controller 601, where the third memory 609 includes a first storage area 607.

In some examples, the third memory 609 is a non-volatile memory or a volatile memory.

In some implementations, the first command includes a command to obtain a program list log page (Get Log Page command).

In implementations of the present disclosure, the program list log page can be generated by the controller 601, information describing each program is recorded in the program list log page, and the program list log page can be stored in the first storage area 607.

It should be noted that, the example of the first command in the above implementations is not used to limit the first command in implementations of the present disclosure, and the first command can also be another command.

In some implementations, a first table is stored in the first storage area 607, and information describing each program is recorded in the first table; and the controller 601 is configured to: record the information related to the time required for executing each program by the computational storage system 600 in the first table.

The first table records information describing each program, and the information related to the time required for executing a program by the computational storage system 600 can be placed in description about the program in the first table, for example, can be put into a space reserved before the first table. The information related to the time required for executing a certain program by the computational storage system 600 may occupy n bytes in units of ms, where n is an integer greater than or equal to 1. If the program is a long-term running program, it may be represented by a predetermined numerical value, and for example may be represented by a numerical value 0xFFFFFFFF, but implementations of the present disclosure is not limited thereto.

In some implementations, the host 605 is configured to: send a second command; the controller 601 is configured to: receive the second command; acquire whether the computational storage system 600 supports querying the information related to the time required for executing each program by the computational storage system 600 in response to the second command; and the host 605 is configured to: send the first command based on the computational storage system 600 supports querying the information related to the time required for executing each program by the computational storage system 600.

Before the host 605 sends the first command, the host 605 first sends the second command to the controller 601, to query whether the computational storage system 600 supports querying the information related to the time required for executing each program by the computational storage system 600, and when the computational storage system 600 supports querying the information related to the time required for executing each program by the computational storage system 600, the host 605 sends the first command to the controller 601; when the computational storage system 600 does not support querying the information related to the time required for executing each program by the computational storage system 600, the host 605 does not send the first command to the controller 601. The electronic system can thus be compatible with that the computational storage system 600 supports and does not support querying the information related to the time required for executing each program by the computational storage system 600.

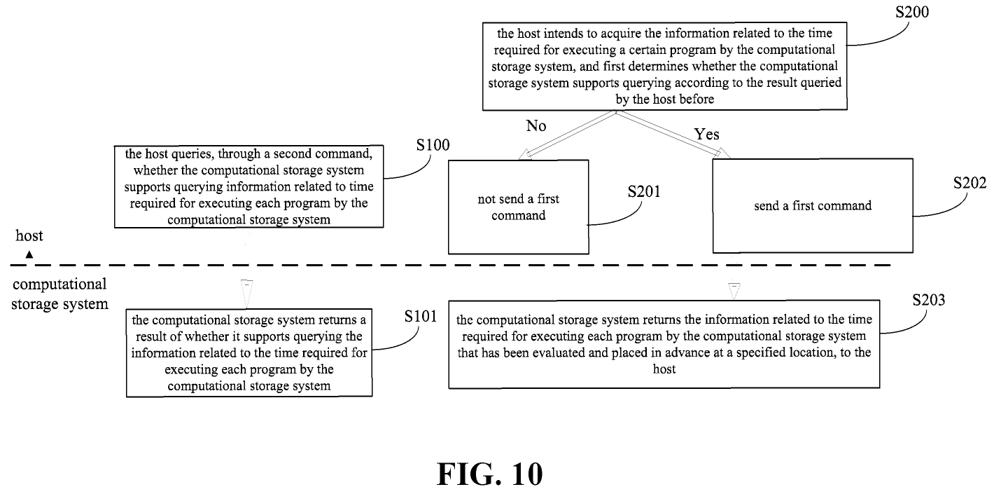

Specifically, as shown in FIG. 10, in step S100, the host queries, through the second command, whether the computational storage system supports querying the information related to the time required for executing each program by the computational storage system; in step S101, the computational storage system returns a result of whether it supports querying the information related to the time required for executing each program by the computational storage system; in step S200, the host intends to acquire the information related to the time required for executing a certain program by the computational storage system, and first determines whether the computational storage system supports querying according to the result queried by the host before; in the step S201, the host determines that the computational storage system does not support querying the information related to the time required for executing each program by the computational storage system, and the host does not send the first command; in step S202, the host determines that the computational storage system supports querying the information related to the time required for executing each program by the computational storage system, and then the host sends the first command; in the step S203, when the computational storage system receives the first command, the computational storage system returns the information related to the time required for executing each program by the computational storage system that has been evaluated and placed in advance at a specified location, to the host.

In some implementations, the second command includes an identify command.

It should be noted that, the example of the second command in the above implementation is not used to limit the second command in implementations of the present disclosure, and the second command can also be another implementable command.

In some implementations, a second table is stored in the first storage area 607, and information describing a compute namespace is recorded in the second table; and the controller 601 is configured to: record, in the second table, whether the computational storage system 600 supports querying the information related to the time required for executing each program by the computational storage system 600.

The second table can be used to define an input/output command set specific identification namespace data structure of a computing program command set, the second table records information describing the compute namespace, and whether the computational storage system 600 supports querying the information related to the time required for executing each program by the computational storage system 600 can be placed in the second table, for example, can be put into a space reserved before the second table. Whether the computational storage system 600 supports querying the information related to the time required for executing each program by the computational storage system 600 may occupy m bits, where m is an integer greater than or equal to 1, for example, m is 1, and the user may acquire this information by sending an identify command.

It should be noted that, the location where the computational storage system 600 supports querying whether the information related to the time required for executing each program by the computational storage system 600 provided in the above implementation is merely an example, and is not intended to limit implementations of the present disclosure.

In some implementations, as shown in FIG. 6, the computational storage system 600 includes a second storage area 606 coupled to the controller 601 and a computing processing component 603 configured to execute a program; the controller 601 is configured to: receive a third command; and configure a corresponding storage area in the second storage area 606 for data during the computing processing component 603 executing the program, in response to the third command.

In some implementations, the computing processing component 603 has computing functions, including, but not limited to, computing engines, where computing engine resources may be composed of one or more of a CPU, a FPGA, a GPU, and the like. The computing processing component 603 may be a part of the controller 601 or a part independent of the controller 601.

In some implementations, the computing processing component 603 is configured to: load a program to be executed.

In some implementations, the program to be executed may also not be loaded by the computing processing component 603, such as for a fixed program provided by the manufacturer.

In some examples, the third command may be a command for creating a memory range set, and after receiving the third command, the controller 601 configures a corresponding storage area in the second storage area 606 for data during the computing processing component 603 executing the program, in response to the third command.

Here, the data during the computing processing component 603 executing the program includes input data and output data during the computing processing component 603 executing the program.

In some implementations, the second storage area 606 includes a first sub-storage area configured for the input data during the computing processing component 603 executing the program, and a second sub-storage area configured for the output data during the computing processing component 603 executing the program.

In some implementations, as shown in FIG. 7, the first memory 602 includes a second storage area 606, where the first storage area 607 and the second storage area 606 can belong to the same memory.

In some implementations, as shown in FIG. 8 and FIG. 9, the first memory 602 includes a second storage area 606, where the first storage area 607 and the second storage area 606 may belong to different memories.

In some implementations, as shown in FIG. 6, the computational storage system 600 further includes a third storage area 608 coupled to the controller 601; the controller 601 is configured to: write the input data during program execution stored in the third storage area 608 into the second storage area 606; and write the output data during program execution stored in the second storage area 606 into the third storage area 608.

In some implementations, as shown in FIG. 7 and FIG. 9, the second memory 604 includes a third storage area 608, where the third storage area 608 and the first storage area 607 can belong to different memories.

In some implementations, as shown in FIG. 8, the second memory 604 includes a third storage area 608, where the third storage area 608 and the first storage area 607 can belong to the same memory.

In implementation of the present disclosure, the third storage area 608 and the second storage area 606 belong to different memories.

In some implementations, the controller 601 is configured to: write input data during program execution stored in the third storage area 608 into the second storage area 606; and write output data during program execution stored in the second storage area 606 into the third storage area 608.

In some implementations, the output data during the program execution cannot be written into the third storage area 608, and the host 605 directly reads the output data during the program execution stored in the second storage area 606.

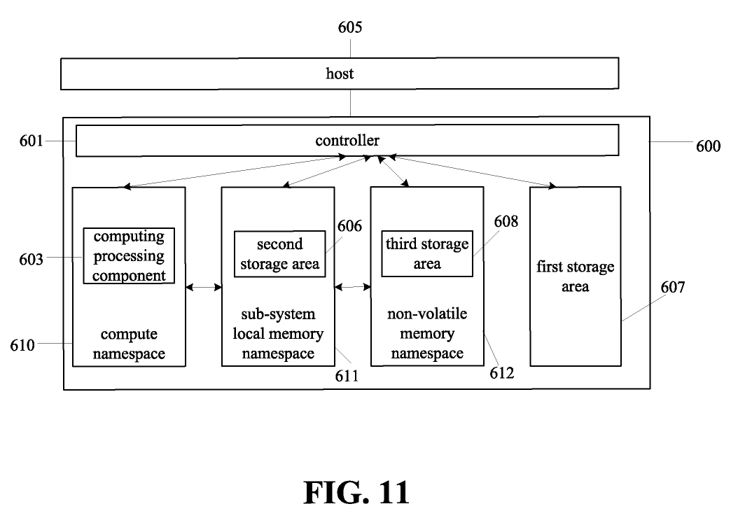

In some implementations, as shown in FIG. 11, the computational storage system 600 includes a non-volatile memory namespace 612, a compute namespace 610, and a sub-system local memory namespace 611; the compute namespace 610 includes a computing processing component 603, the sub-system local memory namespace 611 includes a second storage area 606, and the non-volatile memory namespace 612 includes a third storage area 608.

In implementations of the present disclosure, the first storage area 607 cannot belong to any one of the non-volatile memory namespace 612, the compute namespace 610, and the sub-system local memory namespace 611, and the non-volatile memory namespace 612, the compute namespace 610, and the sub-system local memory namespace 611 can be directly exposed to the host 605 and can directly perform a read/write interaction with the host 605, but the first storage area 607 is not exposed to the host 605 and cannot directly perform a read/write interaction with the host 605, and the host 605 can access the first storage area 607 through a special command such as a command to obtain a program list log page, an identify command, and the like.

According to the scheme provided by implementations of the present disclosure, its implementation is not complex and without the hardware cost; and the host is allowed to acquire the information related to the time required for executing each program by the computational storage system, and the host can perform better estimation on performance.

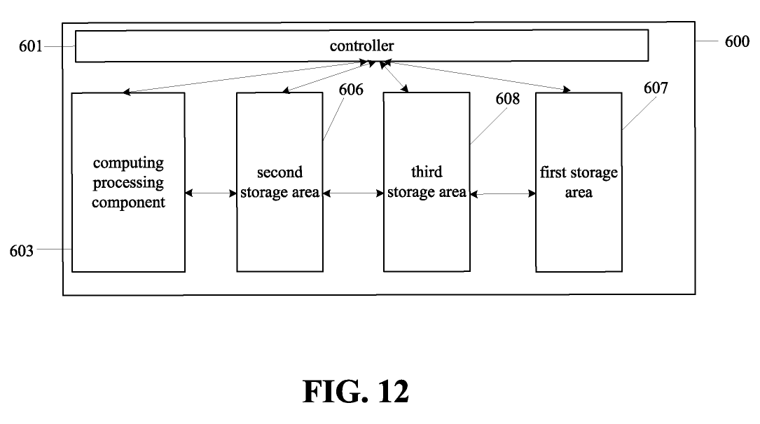

Based on the above electronic system, an implementation of the present disclosure further provides a computational storage system, as shown in FIG. 12, the computational storage system 600 includes a controller 601 and a first storage area 607 coupled to the controller 601, and the controller 601 is configured to: receive a first command; acquire, from the first storage area 607, information related to time required for executing each program by the computational storage system 600 in response to the first command; and send the information related to the time required for executing each program by the computational storage system 600 to the host 605 coupled to the computational storage system 600.

In some implementations, the information related to the time required for executing each program by the computational storage system 600 includes time required for processing a unit data volume when the computational storage system 600 executes each program.

In some implementations, the controller 601 is configured to: receive a second command; acquire whether the computational storage system 600 supports querying the information related to the time required for executing each program by the computational storage system 600, in response to the second command; and receive the first command based on the computational storage system 600 supports querying the information related to the time required for executing each program by the computational storage system 600.

In some implementations, the controller 601 is configured to: calculate the information related to the time required for executing each program by the computational storage system 600 according to a type of each program and a hardware configuration of the computational storage system 600.

In some implementations, the controller 601 is configured to: store the calculated information related to the time required for executing each program by the computational storage system 600 into the first storage area 607.

In some implementations, as shown in FIG. 12, the computational storage system 600 includes a second storage area 606 coupled to the controller 601 and a computing processing component 603 configured to execute a program; the controller 601 is configured to: receive a third command; and configure a corresponding storage area in the second storage area 606 for data during the computing processing component 603 executing the program, in response to the third command.

In some implementations, as shown in FIG. 12, the computational storage system 600 further includes a third storage area 608 coupled to the controller 601; the controller 601 is configured to: write input data during program execution stored in the third storage area 608 into the second storage area 606; and write output data during program execution stored in the second storage area 606 into the third storage area 608. Based on the above electronic system, implementations of the present disclosure further provides a host 605, where the host 605 is configured to: send a first command to a computational storage system 600 coupled to the host 605; acquire, from the computational storage system 600, the information related to the time required for executing each program by the computational storage system 600; and perform task allocation related to program execution according to the information related to the time required for executing each program by the computational storage system 600.

Further details about the above computational storage system 600 and the host 605 are described in detail in the above implementations of the electronic system, and details are not described herein again for brevity.

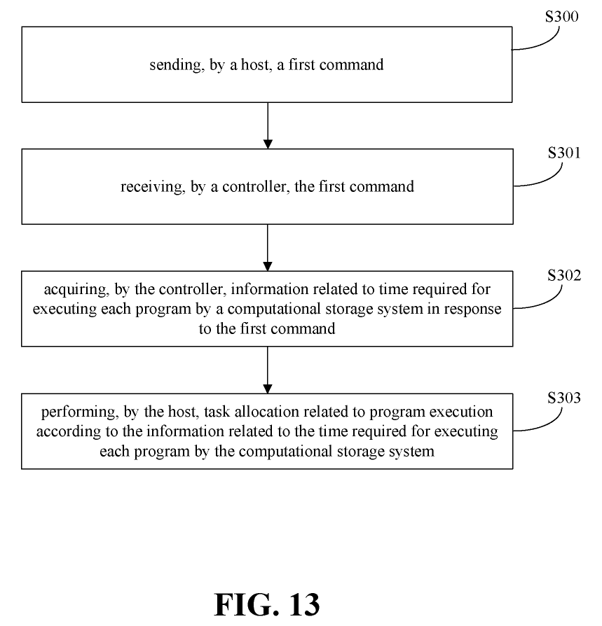

Based on the above electronic system, implementations of the present disclosure further provides an operation method of an electronic system, as shown in FIG. 13, the operation method includes the following steps: step S300, sending, by a host, a first command; step S301, receiving, by a controller, the first command; step S302, acquiring, by the controller, information related to time required for executing each program by a computational storage system in response to the first command; and step S303, performing, by the host, task allocation related to program execution according to the information related to the time required for executing each program by the computational storage system.

In some implementations, the information related to the time required for executing each program by the computational storage system includes time required for processing a unit data volume when the computational storage system executes each program.

In some implementations, the performing, by the host, the task allocation related to the program execution according to the information related to the time required for executing each program by the computational storage system includes: determining, by the host, a program that needs to be executed within the preset time period according to the information related to the time required for executing each program by the computational storage system.

In some implementations, the operation method further includes: sending, by the host, a second command; receiving, by the controller, the second command; acquiring, by the controller, whether the computational storage system supports querying the information related to the time required for executing each program by the computational storage system in response to the second command; and sending, by the host, the first command based on the computational storage system supports querying the information related to the time required for executing each program by the computational storage system.

In some implementations, the operation method further includes: calculating, by the controller, the information related to the time required for the computational storage system to execute each program according to a type of each program and a hardware configuration of the computational storage system.

In some implementations, the computational storage system further includes a first storage area, where the first storage area is coupled to the controller; the operation method further includes: storing the calculated information related to the time required for executing each program by the computational storage system into the first storage area; the acquiring, by the controller, the information related to the time required for executing each program by the computational storage system in response to the first command includes: acquiring, by the controller, the information related to the time required for executing each program by the computational storage system from the first storage area in response to the first command.

In some implementations, a first table is stored in the first storage area, and information describing each program is recorded in the first table; the operation method further includes: recording, by the controller, the information related to the time required for executing each program by the computational storage system in the first table.

In some implementations, the first command includes a command to obtain a program list log page.

In some implementations, a second table is stored in the first storage area, and information describing the compute namespace is recorded in the second table; the operation method further includes: recording, by the controller, whether the computational storage system supports querying the information related to the time required for executing each program by the computational storage system in the second table.

In some implementations, the second command includes an identify command.

The operation method of the electronic system mentioned in the above implementations has been described in detail in the above implementations of the electronic system, and details are not described herein again for brevity.

Based on the above operation method of the electronic system, implementations of the present disclosure further provides a computer-readable storage medium, where the computer-readable storage medium stores computer programs, and when the computer programs are executed by a processor, the operation method of the electronic system according to any one of the above implementations is performed.

Herein, all or part of the processes in the operation method of the electronic system in the above implementations are completed by using computer programs for instructing related hardware, where the programs can be stored in a computer readable storage medium, and the programs, when executed, can include a process of implementations of the above methods. The storage medium may be a magnetic random access memory (FRAM), a read-only memory (ROM), a programmable read-only memory (PROM), an erasable programmable read-only memory (EPROM), an electrically erasable programmable read-only memory (EEPROM), a flash memory, a magnetic surface memory, an optical disc, or a compact disc read-only memory (CD-ROM), and the like; and the storage medium may further include a combination of the above types of memories.

The features disclosed in the several device implementations provided by the present disclosure can be arbitrarily combined without conflict, to acquire a new device implementation.

The methods disclosed in the several method implementations provided by the present disclosure can be arbitrarily combined without conflict, to acquire a new method implementation.

The above descriptions are only specific implementations of the present disclosure, but the protection scope of the present disclosure is not limited thereto, and any person skilled in the art can easily conceive variations or replacements within the technical scope of the present disclosure, which should be covered within the protection scope of the present disclosure.

What is claimed is:

1. An electronic system, comprising:
a host; and
a computational storage system coupled to the host, the computational storage system comprising a controller, wherein:
the host is configured to send a first command;
the controller is configured to:
receive the first command; and
acquire information related to time required for executing each program by the computational storage system in response to the first command; and
the host is further configured to perform task allocation related to program execution according to the information related to the time required for executing each program by the computational storage system.

2. The electronic system according to claim 1, wherein the information related to the time required for executing each program by the computational storage system comprises time required for processing a unit data volume when the computational storage system executes each program.

3. The electronic system according to claim 1, wherein the host is configured to determine a program that needs to be executed within a preset time period according to the information related to the time required for executing each program by the computational storage system.

4. The electronic system according to claim 1, wherein:
the host is configured to send a second command;
the controller is configured to:
receive the second command; and
acquire whether the computational storage system supports querying the information related to the time required for executing each program by the computational storage system in response to the second command; and
the host is further configured to send the first command based on the computational storage system supports querying the information related to the time required for executing each program by the computational storage system.

5. The electronic system according to claim 4, wherein the controller is configured to calculate the information related to the time required for executing each program by the computational storage system according to a type of each program and a hardware configuration of the computational storage system.

6. The electronic system according to claim 5, wherein the computational storage system further comprises a first storage area coupled to the controller, wherein the controller is configured to:
store the calculated information related to the time required for executing each program by the computational storage system into the first storage area; and
acquire, from the first storage area, the information related to the time required for executing each program by the computational storage system in response to the first command.

7. The electronic system according to claim 6, wherein:
a first table is stored in the first storage area, and information describing each program is recorded in the first table; and
the controller is configured to record the information related to the time required for executing each program by the computational storage system in the first table.

8. The electronic system according to claim 7, wherein the first command comprises a command to obtain a program list log page.

9. The electronic system according to claim 6, wherein:
a second table is stored in the first storage area, and information describing a compute namespace is recorded in the second table; and
the controller is configured to record whether the computational storage system supports querying the information related to the time required for executing each program by the computational storage system in the second table.

10. The electronic system according to claim 9, wherein the second command comprises an identify command.

11. The electronic system according to claim 1, wherein:
the computational storage system comprises a computing processing component for executing a program and a second storage area coupled to the controller; and
the controller is configured to:
receive a third command; and
configure a corresponding storage area in the second storage area for data during the computing processing component executing the program, in response to the third command.

12. The electronic system according to claim 11, wherein:
the computational storage system further comprises a third storage area coupled to the controller; and
the controller is configured to:
write input data during program execution stored in the third storage area into the second storage area; and
write output data during program execution stored in the second storage area into the third storage area.

13. The electronic system according to claim 12, wherein:
the computational storage system further comprises a non-volatile memory namespace, a compute namespace, and a sub-system local memory namespace; and
the compute namespace comprises the computing processing component, the sub-system local memory namespace comprises the second storage area, and the non-volatile memory namespace comprises the third storage area.

14. A computational storage system, comprising a controller and a first storage area coupled to the controller, the controller being configured to:
receive a first command;
acquire, from the first storage area, information related to time required for executing each program by the computational storage system in response to the first command; and
send the information related to the time required for executing each program by the computational storage system to a host coupled to the computational storage system.

15. The computational storage system according to claim 14, wherein the information related to the time required for executing each program by the computational storage system comprises time required for processing a unit data volume when the computational storage system executes each program.

16. The computational storage system according to claim 14, wherein the controller is configured to:
receive a second command;
acquire whether the computational storage system supports querying the information related to the time required for executing each program by the computational storage system in response to the second command; and
receive the first command based on the computational storage system supports querying the information related to the time required for executing each program by the computational storage system.

17. An operation method of an electronic system, comprising:
sending, by a host, a first command;
receiving, by a controller, the first command;
acquiring, by the controller, information related to time required for executing each program by a computational storage system in response to the first command; and
performing, by the host, task allocation related to program execution according to the information related to the time required for executing each program by the computational storage system.

18. The operation method according to claim 17, wherein the information related to the time required for executing each program by the computational storage system comprises time required for processing a unit data volume when the computational storage system executes each program.

19. The operation method according to claim 17, wherein the performing, by the host, the task allocation related to program execution according to the information related to the time required for executing each program by the computational storage system comprises determining, by the host, a program that needs to be executed within a preset time period according to the information related to the time required for executing each program by the computational storage system.

20. The operation method according to claim 17, further comprising:
sending, by the host, a second command;
receiving, by the controller, the second command;
acquiring, by the controller, whether the computational storage system supports querying the information related to the time required for executing each program by the computational storage system in response to the second command; and
sending, by the host, the first command based on the computational storage system supports querying the information related to the time required for executing each program by the computational storage system.
